(19) United States
(12) Patent Application Publication
(10) Pub. No.: US 2013/0148526 A1
(43) Pub. Date: Jun. 13, 2013

(54) APPARATUS AND METHOD FOR CONTROLLING GROUP SETTING IN DEVICE-TO-DEVICE COMMUNICATION

(71) Applicant: Electronics and Telecommunications Research In, Daejeon (KR)

(72) Inventors: You Sun HWANG, Seoul (KR); Jae Sheung SHIN, Daejeon (KR); Ae Soon PARK, Daejeon (KR)

(73) Assignee: Electronics and Telecommunications Research Institute, Daejeon (KR)

(21) Appl. No.: 13/706,797

(22) Filed: Dec. 6, 2012

(30) Foreign Application Priority Data
Dec. 7, 2011 (KR) 10-2011-0130197

(51) Int. Cl. H04W 4/08; H04W 24/10

(52) U.S. Cl. CPC H04W 4/08; H04W 24/10
USPC 370/252; 370/312

(57) ABSTRACT

Provided is a device-to-device (D2D) group communication control method. In the D2D group communication control method, D2D group session information is generated and transmitted when a D2D group service request or a D2D group communication sensing report is received. When a D2D group session confirmation message is received according to the D2D group service request or the D2D group communication sensing report, D2D group session setup is determined to be successful. A D2D group service response message or a D2D group service start message is transmitted to at least one device belonging to a D2D group for which the D2D group session setup is completed. Thereby, centralized D2D group session management can be performed. Accordingly, the number of connections of separate direct communication can be reduced and hence a signaling load can be reduced.

### CLAIM FOR PRIORITY

This application claims priority to Korean Patent Application No. 10-2011-0130197 filed on Dec. 7, 2011 in the Korean Intellectual Property Office (KIPO), the entire contents of which are hereby incorporated by reference.

### BACKGROUND

1. Technical Field

Example embodiments of the present invention relate in general to the field of device-to-device (D2D) communication and more specifically to an apparatus and method for controlling a group setting in D2D communication.

2. Related Art

D2D communication is a communication scheme for performing direct data transmission/reception between two adjacent devices without involving a base station. That is, the two devices serve as a data source and a data destination to perform communication.

Recently, the above-described D2D communication in a cellular mobile communication system has been actively discussed. This is because a network capacity, a data transmission rate, and good service quality at which service can be provided to many users are required with a rapid increase in data traffic according to the wide use of various communication devices. The D2D communication is considered to be a means for satisfying requirements of users while improving the performance of an existing communication network at a low cost.

The discussion of a concept of the D2D communication first began in fields such as sensor networks and wireless fidelity (Wi-Fi) direct networks. Recently, D2D communication based on a cellular system has also begun in 3rd Generation Partnership Project (3GPP) systems.

There is an advantage in terms of the wide coverage and resource reuse of a macro cell when the D2D communication based on the cellular system is performed. It is preferable that D2D communication among three or more devices also be able to provide various services (multi-point video conferencing and multicast service, and the like).

Accordingly, a function of managing and setting a one-to-N or N-to-N group communication service is also necessary in addition to a function of maintaining one-to-one communication in the D2D communication. However, no specific scheme for specific D2D group management of the D2D communication has been proposed up to now.

### SUMMARY

Accordingly, example embodiments of the present invention are provided to substantially obviate one or more problems due to limitations and disadvantages of the related art.

Example embodiments of the present invention provide a D2D group communication control method.

Example embodiments of the present invention also provide a D2D control apparatus for controlling a group setting in D2D communication.

Example embodiments of the present invention also provide a D2D communication method.

Example embodiments of the present invention also provide a D2D device for performing D2D communication.

In some example embodiments, a D2D group communication control method for use in a D2D control apparatus located in a mobile communication network includes receiving a D2D group service request or a D2D group communication sensing report; generating D2D group session information in response to the D2D group service request or the D2D group communication sensing report to transmit the generated D2D group session information to a policy control and charging rules function (PCRF) apparatus; determining that D2D group session setup is successful when a D2D group session confirm message is received from the PCRF apparatus; and transmitting a D2D group service response message or a D2D group service start message to at least one device belonging to a D2D group for which the D2D group session setup is successfully completed.

In the D2D group communication control method, the D2D group service request may be received from at least one device.

The D2D group communication sensing report may be received from an entity within the network. In this case, an example embodiment of the entity within the network may be a gateway.

On the other hand, the D2D group service response message may be transmitted to at least one device that has requested a D2D group service, and the D2D group service start message may be transmitted to at least one device that has not requested a D2D group service, but belongs to the D2D group for which the D2D group session setup is successfully completed.

In other example embodiments, a D2D control apparatus, which is located in a mobile communication network and controls D2D group communication, includes a transceiver configured to receive a D2D group service request or a D2D group communication sensing report; a D2D session information generator configured to generate D2D group session information; and a controller configured to control the D2D session information generator to generate the D2D group session information in response to the D2D group service request or the D2D group communication sensing report.

In the D2D control apparatus, the controller may generate at least one of a D2D group service response message and a D2D group service start message by determining that D2D group session setup is successful when receiving a D2D group session confirm message from a PCRF apparatus located in the network.

On the other hand, the transceiver may transmit the D2D group session information generated by the D2D session information generator to a PCRF apparatus. The transceiver may transmit at least one of the D2D group service response message and the D2D group service start message to at least one device belonging to a D2D group for which the D2D group session setup is successfully completed.

In still other example embodiments, a D2D communication method includes transmitting a D2D group service request for group communication with two or more devices to a network; receiving a radio measurement report request for D2D group communication from the network; performing radio measurement for a wireless link to two or more devices to perform group communication with so as to transmit a report for a measurement result value to the network; and receiving a D2D group service response message from the network to perform the group communication with the two or more devices.

In still other example embodiments, a D2D communication method includes receiving a radio measurement report request for D2D group communication from a network; performing radio measurement for a wireless link to two or more devices to perform group communication with, so as to transmit a report for a measurement result value to the network; receiving a D2D group service start message from the network; and performing the group communication with the two or more devices.

In still other example embodiments, a D2D device includes a D2D controller configured to determine whether or not there is group communication with two or more devices and control a radio transceiver to transmit a D2D group service request to a network; and the radio transceiver configured to receive a radio measurement report request for D2D group communication from the network, perform radio measurement for a wireless link to two or more devices to perform group communication with, and transmit a report for a measurement result value to the network simultaneously when the report is transmitted to the D2D controller.

The D2D device may further include a storage configured to store an application for the D2D group communication and information related to the D2D group communication. In addition, the D2D controller may receive a D2D group service response message or a D2D group service start message from the network and enable the group communication with the two or more devices to be performed.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating a concept of D2D communication;

FIG. 2 is a conceptual diagram illustrating a group setting when D2D group communication is performed according to an example embodiment of the present invention;

FIG. 3 is a diagram illustrating a flow of messages exchanged among network components and devices generated in a group communication setup procedure when there is a group communication request from a device according to an example embodiment of the present invention;

FIG. 4 is a diagram illustrating a flow of messages exchanged among network components and devices generated in a group communication setup procedure when D2D group communication is sensed in a network according to an example embodiment of the present invention;

FIG. 5 is a diagram illustrating a flow of messages exchanged among network components and devices generated in a group communication setup procedure when a device additionally joins preset D2D group communication according to an example embodiment of the present invention;

FIG. 6 is a block diagram illustrating a configuration of a D2D control apparatus according to an example embodiment of the present invention;

FIG. 7 is a block diagram illustrating a configuration of a device according to an example embodiment of the present invention;

FIG. 8 is a flowchart illustrating a detailed operation of a D2D group communication control method according to an example embodiment of the present invention;

FIG. 9 is a flowchart illustrating an operation of the device that performs D2D communication according to an example embodiment of the present invention; and

FIG. 10 is a flowchart illustrating an operation of the device according to another example embodiment of the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “device” used herein may be referred to as a mobile station (MS), user equipment (UE), user terminal (UT), wireless terminal, access terminal (AT), subscriber unit, subscriber station (SS), wireless device, wireless communication device, wireless transmit/receive unit (WTRU), mobile node, mobile, or other terms. Various embodiments of a device may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or devices having a combination of such functions, but are not limited thereto.

The term “base station” used herein generally denotes a fixed or mobile point that communicates with a device, and may be referred to as a Node-B, evolved Node-B (eNB), base transceiver system (BTS), access point, relay, femto-cell, and other terms.

Hereinafter, preferred embodiments of the present invention will be described in more detail with reference to the accompanying drawings. To facilitate the entire understanding of the invention, the same reference numerals in the drawings denote the same elements, and repetitive description of the same elements is omitted.

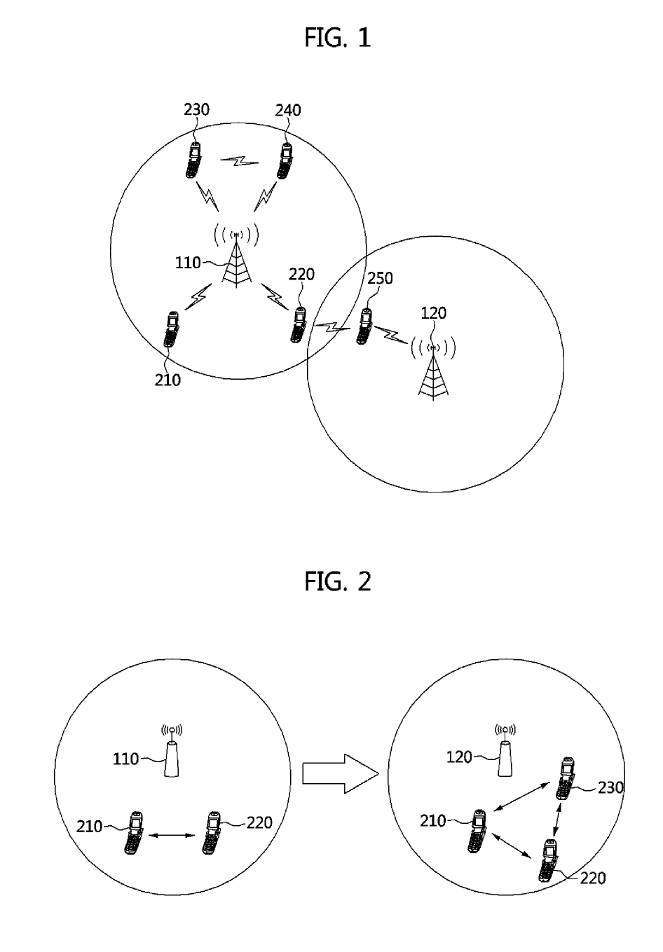

FIG. 1 is a conceptual diagram illustrating a concept of D2D communication.

Referring to FIG. 1, a cellular communication network including a first base station 110 and a second base station 120 is illustrated.

It can be seen that device 1 (210) and device 2 (220) belonging to a cell generated by the first base station perform communication using a general connection link through the first base station, but device 3 (230) and device 4 (240) directly perform mutual data transmission/reception without involving the base station in spite of belonging to the first base station.

This D2D communication can be effectively used in various examples. For example, the D2D communication can be used for a local media server and the like that provide a large volume of data to visitors attending a concert and the like.

Again referring to FIG. 1, it can be seen that a D2D link can be connected not only between devices for which serving cells are the same, but also between devices for which serving cells are different. That is, in FIG. 1, device 2 (220) belonging to the first base station 110 performs D2D communication with device 5 (250) belonging to the second base station 120.

This D2D communication includes D2D communication based on a centralized control scheme and D2D communication based on a distributed control scheme.

The D2D communication based on the centralized control scheme is a scheme in which a device desiring to communicate with another device requests a central node (a base station in a cellular network) to set up a link and the central node enables communication between the devices to be performed by allocating radio resources with which the two devices can perform direct communication when a communication partner device, that is, the other device, is located around the device.

At this time, an operation occurring in the device is usually managed by the central node, and radio resources allocated for a cellular link or another D2D link can be reused for D2D communication.

On the other hand, the D2D communication based on the distributed control scheme is a scheme in which a link is set up by the distributed control scheme through a direct signal exchange between devices independent of one central control node, and a direct data exchange with a peripheral device is performed using the set-up link.

A D2D control method according to an example embodiment of the present invention can be more suitable for the D2D communication based on the centralized control scheme rather than the D2D communication based on the distributed control scheme.

FIG. 2 is a conceptual diagram illustrating a group setting when D2D group communication is performed according to an example embodiment of the present invention.

For group communication, there are a method in which the group communication is set up by a device and a method in which the group communication is set up in a network. When the group communication is started by a device, one device may be added while two devices perform direct communication and hence the three devices may perform direct communication. For example, as illustrated in FIG. 2, device 3 (230) may additionally join communication between device 1 (210) and device 2 (220) while the communication between device 1 (210) and device 2 (220) is performed.

In addition to this case, two or more devices may simultaneously make direct group communication requests. In addition, communication among four or more devices as well as communication among three devices illustrated in FIG. 2 may be considered. In this case, group communication setup is advantageous in terms of radio resource utilization and signaling is also significantly easy.

On the other hand, when a result of monitoring in a network indicates that data communication is continuously performed among many devices, a group generation request may be first generated from the network so that group communication is performed.

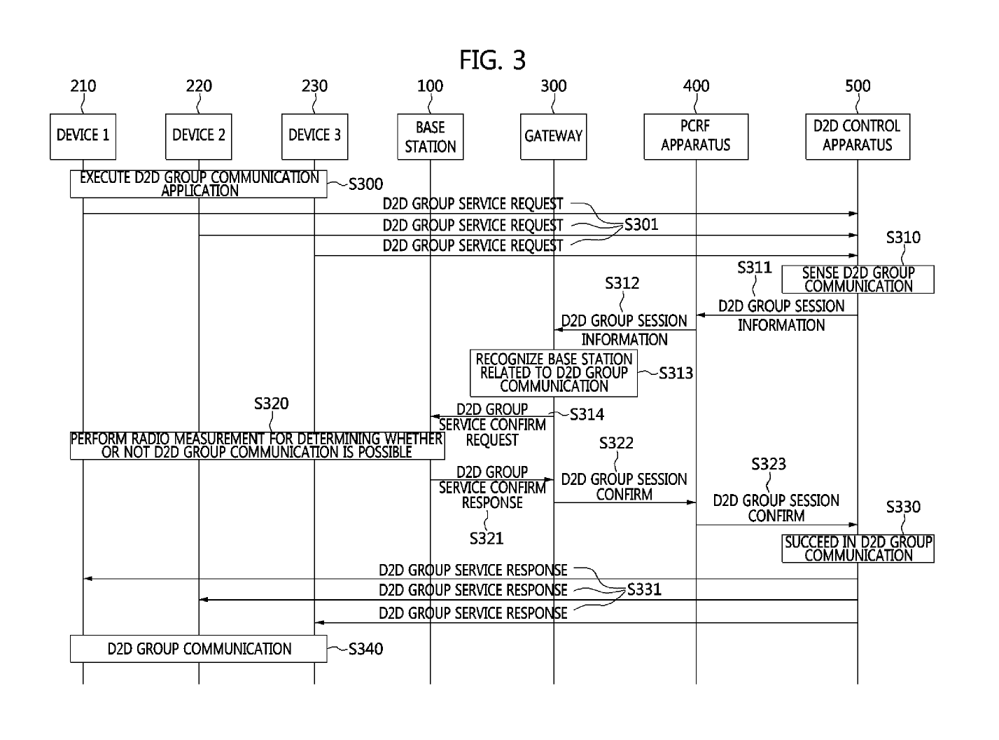

Hereinafter, network components, operations of devices, and flows of messages exchanged between the components in various cases in which the group communication is performed will be described in detail with reference to FIGS. 3 to 5.

FIG. 3 is a diagram illustrating a flow of messages exchanged among network components and devices in a group communication setup procedure when there is a group communication request from the device according to an example embodiment of the present invention.

First, components of a network to which example embodiments of the present invention are applied will be described. The network to which the present invention is applicable includes one or more devices 210 to 230 and the base station 100 as described with reference to FIGS. 1 and 2. Additionally, as illustrated in FIG. 3, the network may include a gateway 300, a PCRF apparatus 400, and a D2D control apparatus 500.

The D2D control apparatus 500 according to an example embodiment of the present invention performs a session management function for a D2D group service. Here, the D2D control apparatus 500 may be an application server separate from other entities within the network and may be a block that manages a D2D group within any entity located in a core network.

The gateway 300 performs a function of connecting a core network including the PCRF apparatus 400 and the D2D control apparatus 500 to a wireless connection network including the base station 100.

The PCRF apparatus 400 is responsible for a charging function in which a fee differs according to a user's subscription condition, a roaming service, a payment plan, or the like, and a policy control function of controlling the use of packet exchange services. Here, the policy control function is, for example, a function of preventing users from employing a data rate that is higher than a permitted data rate and controlling the users to access only permitted services or web sites.

An operation flow between the above-described components when the group communication is triggered from the device will be described with reference to FIG. 3.

As illustrated in FIG. 3, one or more devices 210, 220, and 230 execute an application for the group communication (S300). Thereafter, each device transmits a request message for D2D group communication to a wireless connection network. This message is delivered to the D2D control apparatus 500 through the base station 100, the gateway 300, and the like (S301).

The D2D control apparatus 500 receives a group communication request message delivered from the device through the wireless connection network, and senses D2D group communication (S310). The D2D control apparatus 500 generates session information for a D2D group service and delivers the session information for the D2D group service to the PCRF apparatus 400 (S311). The PCRF apparatus 400 reads device information, reads information for a group session, and delivers the D2D group session information to the gateway 300 (S312).

The gateway 300 recognizes a base station related to corresponding D2D group communication based on the group session information received from the PCRF apparatus 400 (S313). That is, the gateway determines whether at least one device joining the corresponding D2D group communication is controlled by one base station (eNB) or a plurality of base stations. The gateway 300 transmits a group service confirm request message to at least one related base station after checking at least one base station (S314).

Thereafter, the base station and the devices related to the group communication perform measurement for the D2D group communication, that is, a radio measurement procedure (S320). In other words, the base station checks devices belonging to a corresponding D2D group and then requests the related devices to report measurement information so as to allocate radio resources to be used for a D2D group service. Here, a measurement report request message transmitted from the base station to at least one device can include elements such as a measurement target, a reporting configuration, a measurement identifier, and a quantity configuration.

The device receiving the measurement report request message from the base station measures a link to the other devices belonging to a corresponding D2D group, and transmits a measurement report reflecting a result value to the base station. The base station 100 determines whether or not a D2D group service is possible based on measurement values received from the related devices, and performs a setting necessary for the D2D group service such as allocation of radio resources to be used from the D2D group service if the D2D group service is possible.

After completing all settings for the D2D group service, the base station 100 transmits a D2D group service confirm response to the gateway 300 (S321).

The gateway 300 receiving the D2D group service confirm response from the base station transmits a D2D group session confirm message to the PCRF apparatus 400 (S322). The PCRF apparatus 400 receiving the D2D group session confirm message transmits the D2D group session confirm message to the D2D control apparatus 500 (S323).

When determining that session setup is successful (S330), the D2D control apparatus 500 receiving the D2D group session confirm message reports setting completion for a corresponding D2D group by transmitting a D2D group service response to the device belonging to the D2D group (S331). Thereby, D2D group communication with at least one device belonging to the D2D group can be performed (S340).

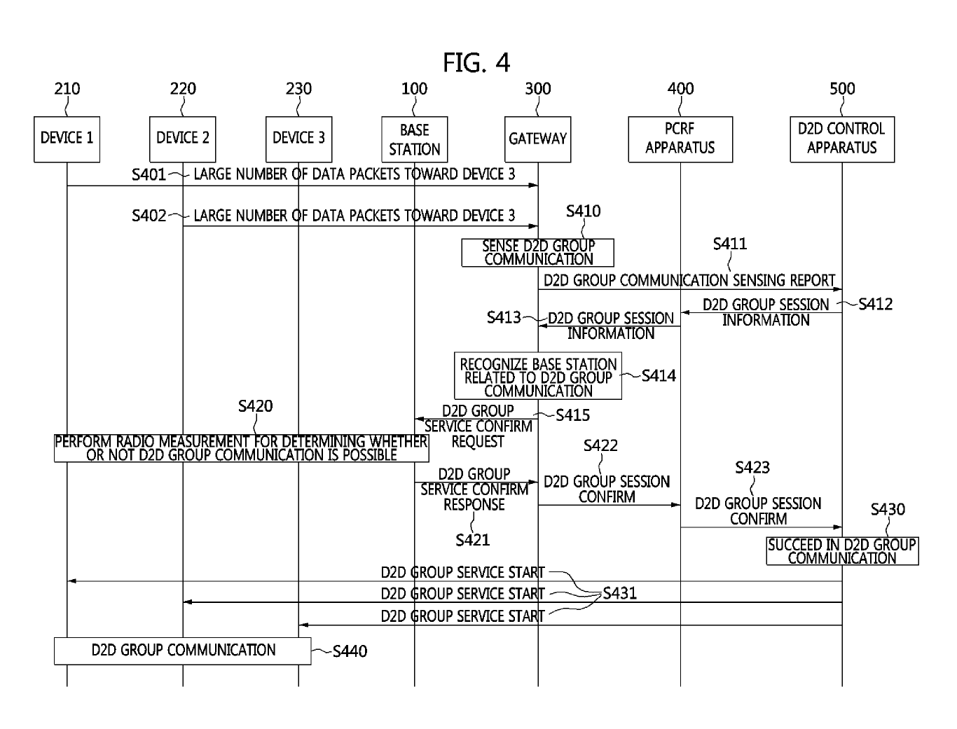

FIG. 4 is a diagram illustrating a flow of messages exchanged among network components and devices generated in a group communication setup procedure when D2D group communication is sensed in a network according to an example embodiment of the present invention.

Unlike the example embodiment illustrated in FIG. 3, the example embodiment of the present invention illustrated in FIG. 4 is an example embodiment in which frequent data transmission is sensed in the network when the data transmission between specific devices is frequent while a packet exchanged between the devices is monitored in the network, and session setup for D2D group communication is initiated.

For example, when sensing frequent data packets (for example, 100 data packets) directed from device 1 (210) to device 3 (230) (S401), and also sensing frequent data packets (for example, 85 data packets) directed from device 2 (220) to device 3 (230) (S402), the gateway 300 located in the network as in FIG. 4 can sense that communication is D2D group communication (S410). That is, the gateway 300 can first initiate a D2D group communication setup procedure for devices requiring a D2D group communication service while monitoring the data packets within the network. The gateway 300 sensing the D2D group communication reports that the D2D group communication has been sensed to the D2D control apparatus 500 (S411).

The D2D control apparatus 500 receives a D2D group communication sensing report from the gateway 300, generates session information for a D2D group service, and delivers the session information for the D2D group service to the PCRF apparatus 400 (S412). The PCRF apparatus 400 reads device information, reads information for a group session, and delivers the D2D group session information to the gateway 300 (S413).

The gateway 300 recognizes a base station related to the D2D group communication based on the group session information received from the PCRF apparatus 400 (S414). The gateway 300 transmits a group service confirm request message to at least one related base station after checking at least one base station (S415).

Thereafter, the base station and the devices related to group communication perform a radio measurement procedure for the D2D group communication (S420). Because the measurement procedure has been described in detail with reference to the example embodiment of FIG. 3, additional description is omitted here. Thereafter, the base station determines whether or not the D2D group service is possible using measurement values received from the related devices, and performs a setting necessary for the D2D group service such as allocating a radio resource to be used for the D2D group service when the D2D group service is possible.

After completing all settings for the D2D group service, the base station transmits a D2D group service confirm response to the gateway 300 (S421). The gateway 300 receiving the D2D group service confirm response from the base station transmits a D2D group session confirm message to the PCRF apparatus 400 (S422). The PCRF apparatus 400 transmits a D2D group session confirm message to the D2D control apparatus 500 (S423).

When determining that D2D group session setup is successful (S430), the D2D control apparatus 500 receiving the D2D group session confirm message reports that the D2D group service is initiated by transmitting a D2D group service start message to devices belonging to a D2D group. Thereby, D2D group communication between the devices belonging to the D2D group can be performed (S440).

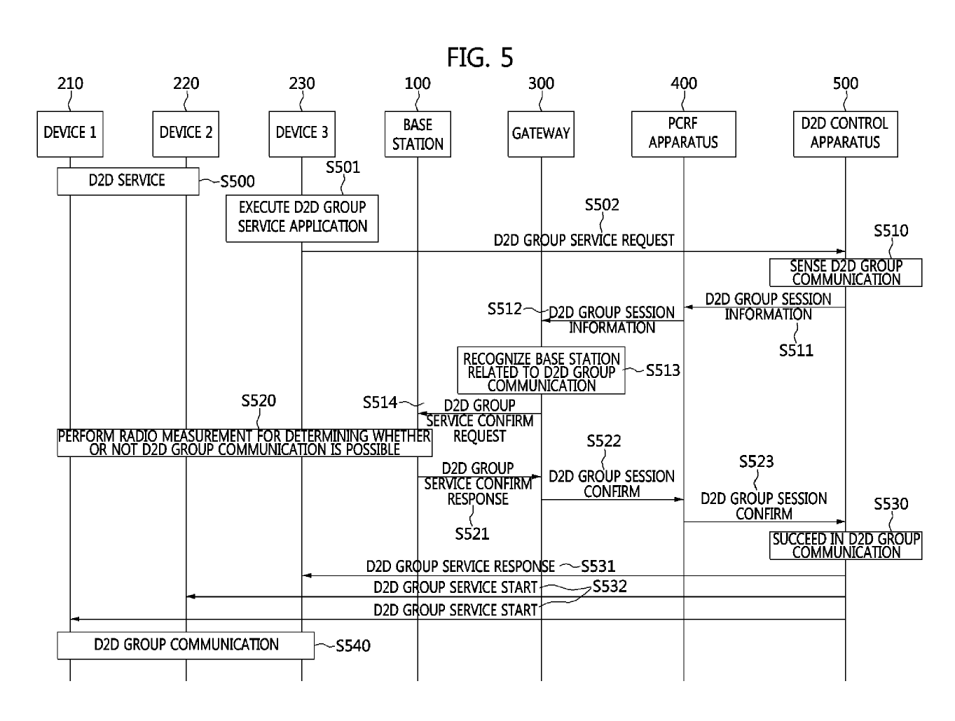

FIG. 5 is a diagram illustrating a flow of messages exchanged among network components and devices generated in a group communication setup procedure when a device additionally joins preset D2D group communication according to an example embodiment of the present invention.

That is, FIG. 5 illustrates operations of components and a flow of messages exchanged between the components when (one or more) other devices join D2D group communication in a state in which D2D communication between two devices is already in progress.

In FIG. 5, it is assumed that a new device 230 makes a group service request when existing device 1 (210) and device 2 (220) are in a D2D communication state (S500). That is, if the new device 230 executes a D2D group service application (S501), a D2D group service request message is transmitted to the D2D control apparatus 500 through the base station 100, the gateway 300, and the like (S502).

When sensing the D2D group service (S510), the D2D control apparatus generates session information for a D2D group service and delivers the session information for the D2D group service to the PCRF apparatus 400 (S511). The PCRF apparatus 400 reads device information, reads information for a group session, and delivers the D2D group session information to the gateway 300 (S512).

The gateway 300 recognizes a base station related to the D2D group communication based on the group session information received from the PCRF apparatus 400 (S513). The gateway 300 transmits a group service confirm request message to at least one related base station after checking at least one base station (S514).

Thereafter, the base station and the devices related to group communication perform a radio measurement procedure for the D2D group communication (S520). Because the measurement procedure has been described in detail with reference to the example embodiment of FIG. 3, detailed description is omitted here.

After completing all settings for the D2D group service, the base station transmits a D2D group service confirm response to the gateway 300 (S521). The gateway 300 receiving the D2D group service confirm response from the base station transmits a D2D group session confirm message to the PCRF apparatus 400 (S522). The PCRF apparatus 400 transmits the D2D group session confirm message to the D2D control apparatus 500 (S523).

When determining that D2D group session setup is successful (S530), the D2D control apparatus 500 receiving the D2D group session confirm message transmits a D2D group service response to a device requesting the D2D group service (S531). On the other hand, a message indicating D2D group service initiation is transmitted to other devices that do not make the D2D group service request and belong to a corresponding D2D group (S532). Thereby, D2D group communication between the devices belonging to the D2D group can be performed (S540).

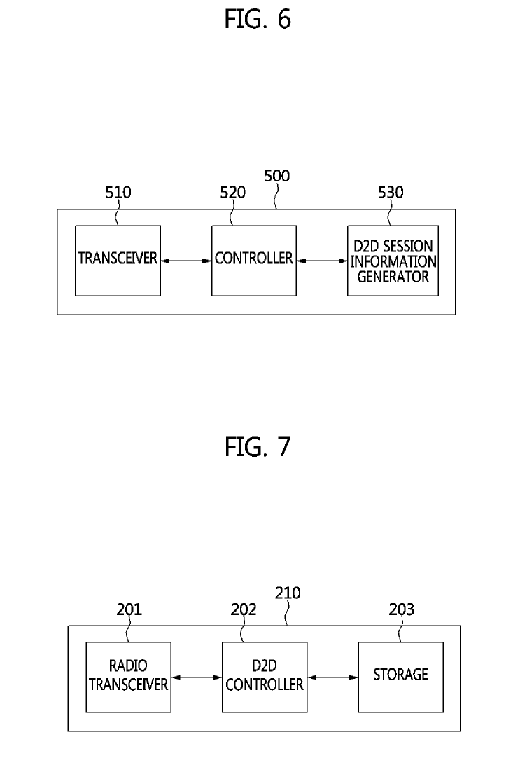

FIG. 6 is a block diagram illustrating a configuration of a D2D control apparatus according to an example embodiment of the present invention.

The D2D control apparatus 500 of FIG. 6 according to the example embodiment of the present invention is a network entity that is located in a mobile communication network to control D2D group communication. However, the D2D control apparatus may be a partial functional block of another entity within the network.

Referring to FIG. 6, the D2D control apparatus 500 can include a D2D session information generator 530, which generates D2D group session information, and a control section 520, which controls the D2D session information generator to generate the D2D group session information according to a D2D group service request and a D2D group communication sensing report.

The D2D group service request is generated from the device and reaches the D2D control apparatus through network elements such as a base station and a gateway. In addition, the D2D group communication sensing report is in the form of a message that is transmitted to the D2D control apparatus if the D2D group communication is determined to be necessary while one of entities of the network monitors traffic generated from at least one device. According to an example embodiment of the present invention, the D2D group communication sensing report can be received from the gateway because the gateway senses the D2D group communication.

When receiving a D2D group session confirm message from the PCRF apparatus, the controller 520 can determine that D2D group session setup is successful and generate a D2D group service response message or a D2D group service start message to be transmitted to at least one device that belongs to a D2D group for which the D2D group session setup is successfully completed.

The D2D control apparatus 500 according to an example embodiment of the present invention may further include a transceiver 510. The transceiver 510 receives a D2D group service request or a D2D group communication sensing report, provides the received D2D group service request or D2D group communication sensing report to the controller 520, and transmits D2D group session information generated by the D2D session information generator 530 to the PCRF apparatus 400.

The transceiver 510 may also transmit the D2D group service response message or the D2D group service start message to at least one device belonging to the D2D group for which the D2D group session setup is successfully completed.

FIG. 7 is a block diagram illustrating a configuration of a device according to an example embodiment of the present invention.

Referring to FIG. 7, the device according to the example embodiment of the present invention can include a radio transceiver 201, a D2D controller 202, and a storage 203.

The radio transceiver 201 wirelessly transmits and receives all data to be exchanged for communication between the device and a base station. The radio transceiver 201 also receives a radio measurement report request for D2D group communication from a network, performs radio measurement for a wireless link to two or more devices that perform group communication, and transmits a report for a measurement result value to the network simultaneously when the report is transmitted to the D2D controller.

The D2D controller 202 analyzes various forms of messages or data input to the radio transceiver 201, determines whether or not there is group communication with two or more devices, and controls the radio transceiver to transmit a D2D group service request to the network.

The storage 203 stores an application for group communication and information related to D2D group communication.

When receiving a D2D group service response message or a D2D group service start message from the network, the D2D controller controls elements of the device so that the group communication with the two or more devices is performed using the application for the D2D group communication and the information related to the D2D group communication stored in the storage.

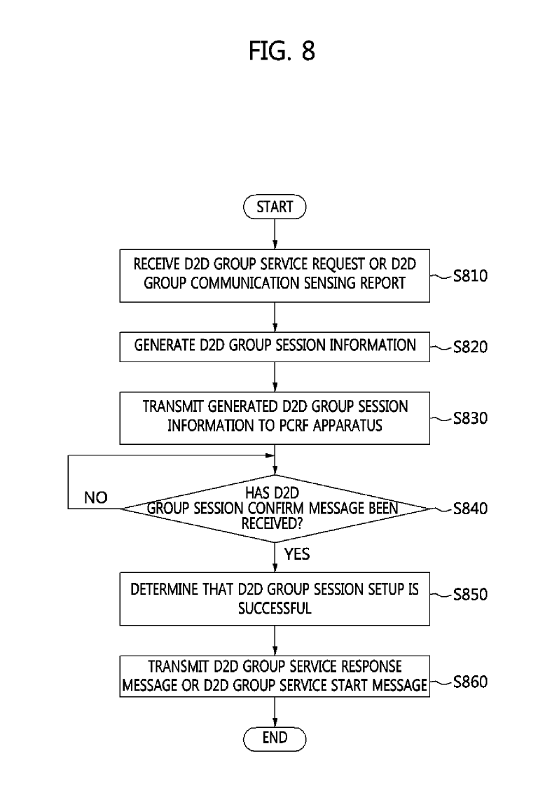

FIG. 8 is a flowchart illustrating a detailed operation of a D2D group communication control method according to an example embodiment of the present invention.

FIG. 8 illustrates the D2D group communication control method capable of being performed by a D2D control apparatus located in a mobile communication network.

First, the D2D control apparatus receives a D2D group service request or a D2D group communication sensing report (S810). Here, the D2D group service request can be received from at least one device. In addition, the D2D group communication sensing report can be received from an entity within the network. The entity within the network is a gateway according to an example embodiment of the present invention.

The D2D control apparatus generates D2D group session information in response to the D2D group service request or D2D group communication sensing report (S820), and transmits the generated D2D group session information to the PCRF apparatus (S830).

Thereafter, when receiving a D2D group session confirm message while waiting for the D2D group session confirm message to be received from the PCRF apparatus (S840), the D2D control apparatus determines that D2D group session setup is successful (S850).

The D2D control apparatus transmits a D2D group service response message or a D2D group service start message to at least one device that belongs to a D2D group for which D2D group session setup is successfully completed (S860). At this time, the D2D group service response message can be transmitted to at least one device that has requested the D2D group service. In addition the D2D group service start message is transmitted to at least one device that has not made a D2D group service request but belongs to the D2D group for which D2D group session setup is successfully completed.

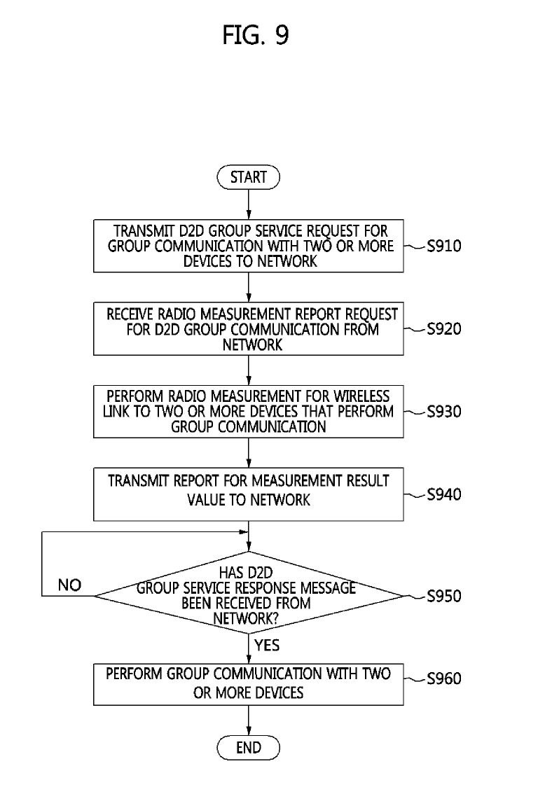

FIG. 9 is a flowchart illustrating an operation of the device that performs D2D communication according to an example embodiment of the present invention.

FIG. 9 illustrates a flow of an operation in a device that recognizes the necessity of a D2D group service and transmits a request to a network.

Referring to FIG. 9, when determining that the D2D group service is necessary, the device transmits a D2D group service request for group communication with two or more devices to the network (S910).

Thereafter, when receiving a radio measurement report request for the D2D group communication from the network, that is, a network (S920), radio measurement for a wireless link to the two or more devices that perform group communication is performed (S930). The device transmits a report for a measurement result value to the network (S940).

When receiving a D2D group service response message while waiting for the D2D group service response message to be received from the network (S950), the device performs the group communication with the two or more devices (S960).

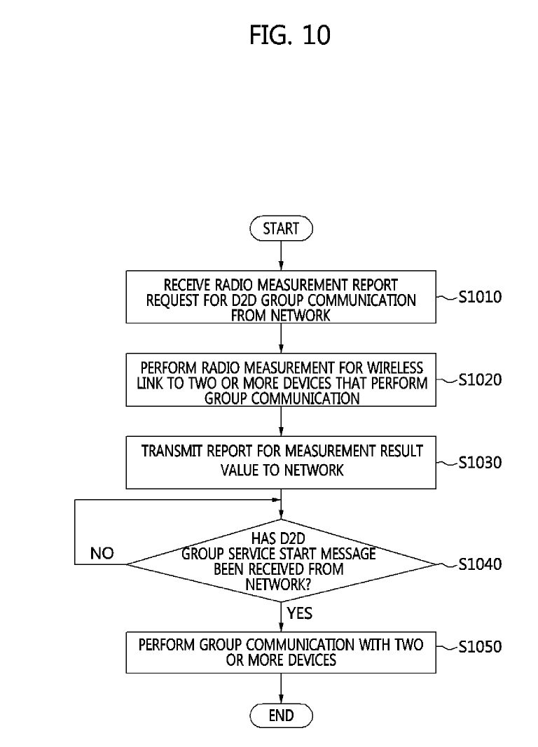

FIG. 10 is a flowchart illustrating an operation of the device according to another example embodiment of the present invention.

FIG. 10 illustrates a flow of an operation in a device when a network first recognizes that a D2D group service is necessary and requests the device to transmit necessary information, not when the device transmits a request to the network.

Referring to FIG. 10, the device receives a radio measurement request for D2D group communication from the network, that is, the base station (S1010). The device performs radio measurement for a wireless link to two or more devices that perform group communication (S1020), and transmits a report for a measurement result value to the network (S1030).

When receiving a D2D group service response message while waiting for the D2D group service response message to be received from the network (S1040), the device performs the group communication with the two or more devices (S1050).

As described above, the operation flow of FIG. 10 is different from the operation flow of FIG. 9 in that the device does not first transmit a D2D group service request to the network.

According to an apparatus and method for controlling a group setting in D2D communication, one network entity is responsible for group session management in D2D group communication, so that centralized D2D group session management can be performed.

Accordingly, the number of connections of separate direct communication can be reduced and hence a signaling load can be reduced.

While the example embodiments of the present invention and their advantages have been described in detail, it should be understood that various changes, substitutions and alterations may be made herein without departing from the scope of the invention.

What is claimed is:

1. A device-to-device (D2D) group communication control method for use in a D2D control apparatus located in a mobile communication network, comprising:
receiving a D2D group service request or a D2D group communication sensing report;
generating D2D group session information in response to the D2D group service request or the D2D group communication sensing report to transmit the generated D2D group session information to a policy control and charging rules function (PCRF) apparatus;
determining that D2D group session setup is successful when a D2D group session confirm message is received from the PCRF apparatus; and
transmitting a D2D group service response message or a D2D group service start message to at least one device belonging to a D2D group for which the D2D group session setup is successfully completed.

2. The D2D group communication control method of claim 1, wherein the D2D group service request is received from at least one device.

3. The D2D group communication control method of claim 1, wherein the D2D group communication sensing report is received from an entity within the network.

4. The D2D group communication control method of claim 2, wherein the D2D group service response message is transmitted to at least one device that has requested a D2D group service.

5. The D2D group communication control method of claim 3, wherein the entity within the network is a gateway.

6. The D2D group communication control method of claim 1, wherein the D2D group service start message is transmitted to at least one device that has not requested a D2D group service, but belongs to the D2D group for which the D2D group session setup is successfully completed.

7. A device-to-device (D2D) communication method comprising:
transmitting a D2D group service request for group communication with two or more devices to a network;
receiving a radio measurement report request for D2D group communication from the network;
performing radio measurement for a wireless link to two or more devices to perform group communication with, so as to transmit a report for a measurement result value to the network; and
receiving a D2D group service response message from the network to perform the group communication with the two or more devices.

8. A device-to-device (D2D) communication method comprising:
receiving a radio measurement report request for D2D group communication from a network;
performing radio measurement for a wireless link to two or more devices to perform group communication with, so as to transmit a report for a measurement result value to the network;
receiving a D2D group service start message from the network; and
performing the group communication with the two or more devices.
